(19) United States
(12) Patent Application Publication
(10) Pub. No.: US 2025/0333108 A1
(43) Pub. Date: Oct. 30, 2025

(54) MOWING PASS ALIGNMENT SYSTEM

(71) Applicant: DEERE & COMPANY, MOLINE, IL (US)

(72) Inventors: VINESH Y. DESHMUKH, PUNE (IN); ROBERT D. DUNBAR, HOLLY SPRINGS, NC (US)

(21) Appl. No.: 18/650,201

(22) Filed: Apr. 30, 2024

(51) Int. Cl. B62D 11/04; A01D 34/00; A01D 34/66; A01D 69/02; A01D 69/03; A01D 101/00

(52) U.S. Cl. CPC B62D 11/04; A01D 34/006; A01D 34/66; A01D 69/02; A01D 69/03; A01D 2101/00

(57) ABSTRACT

A mowing pass alignment system for turning a mower with adjustable cutting width. The mowing pass alignment system includes a mower blade arrangement having an adjustable cutting width, a plurality of wheels including at least one drive wheel configured to provide traction for moving the mower across the ground, a steering mechanism configured to turn the mower, and a controller operatively coupled with the steering mechanism. The controller includes a processor, a memory operatively coupled with the processor, and mowing pass alignment logic stored in the memory and being executable by way of the processor such that the controller is configured to: receive an electronic signal corresponding to the cutting width, and control the steering mechanism to turn the mower into alignment with a next pass based at least in part on the cutting width.

### FIELD OF DISCLOSURE

The present disclosure relates to a mower.

### BACKGROUND

Mowers may be used to cut various types of vegetation, such as grass. Mowers may have adjustable cutting widths.

### SUMMARY

It may be desirable to utilize the available cutting width of a mower by aligning a next pass directly adjacent to a previous pass with little or no overlap. Manually steering the mower through a turn into a target position to begin the next pass can result in misalignment, damaged turf, etc. Furthermore, some mowers have adjustable cutting widths, and it may be difficult for operators to adjust their turns to changes in cutting width. It may be difficult for operators to see the current cutting width. The disclosure provides a mowing pass alignment system to improve alignment of the next pass for mowers having adjustable cutting widths.

In one aspect, the disclosure provides a mowing pass alignment system for turning a mower with adjustable cutting width. The mowing pass alignment system includes a mower blade arrangement having an adjustable cutting width, a plurality of wheels including at least one drive wheel configured to provide traction for moving the mower across the ground, a steering mechanism configured to turn the mower, and a controller operatively coupled with the steering mechanism. The controller includes a processor, a memory operatively coupled with the processor, and mowing pass alignment logic stored in the memory and being executable by way of the processor such that the controller is configured to: receive an electronic signal corresponding to the cutting width, and control the steering mechanism to turn the mower into alignment with a next pass based at least in part on the cutting width.

In another aspect, the disclosure provides a mower. The mower includes a mower blade arrangement having an adjustable cutting width, a plurality of wheels including at least one drive wheel configured to provide traction for moving the mower across the ground, a steering mechanism configured to turn the mower, and a controller operatively coupled with the steering mechanism. The controller includes a processor, a memory operatively coupled with the processor, and mowing pass alignment logic stored in the memory and being executable by way of the processor such that the controller is configured to: receive an electronic signal corresponding to the cutting width, and control the steering mechanism to turn the mower into alignment with a next pass based at least in part on the cutting width.

In yet another aspect, the disclosure provides a mowing pass alignment system for turning a mower with adjustable cutting width. The mowing pass alignment system includes a mower blade arrangement having an adjustable cutting width, a plurality of wheels including at least one drive wheel configured to provide traction for moving the mower across the ground, a steering mechanism configured to turn the mower, and a controller operatively coupled with the steering mechanism. The controller includes a processor, a memory operatively coupled with the processor, and mowing pass alignment logic stored in the memory and being executable by way of the processor such that the controller is configured to: receive an electronic signal corresponding to the cutting width, determine a desired turn path based at least in part on the electronic signal, and execute the desired turn path to align the mower to a next pass.

Other aspects of the disclosure will become apparent by consideration of the detailed description and accompanying drawings.

### BRIEF DESCRIPTION OF THE DRAWINGS

FIG. 1 is a perspective view of a mower having a mowing pass alignment system in accordance with one implementation of the present disclosure.

FIG. 2 is a block diagram of a controller associated with the mower of FIG. 1.

FIG. 3 is a schematic illustration of the mower of FIG. 1 in a first cutting width state making an adaptive turn using the mowing pass alignment system.

FIG. 4 is a schematic illustration of the mower of FIG. 1 in a second cutting width state making an adaptive turn using the mowing pass alignment system.

FIG. 5 is a schematic illustration of the mower of FIG. 1 in the first cutting width state making an operator-controlled turn.

FIG. 6 is a schematic illustration of the mower of FIG. 1 in the second cutting width state making an operator-controlled turn

FIG. 7 is a flow chart illustrating mowing pass alignment logic of the mowing pass alignment system of FIG. 1.

### DETAILED DESCRIPTION

Before any constructions of the disclosure are explained in detail, it is to be understood that the disclosure is not limited in its application to the details of construction and the arrangement of components set forth in the following description or illustrated in the accompanying drawings. The disclosure is capable of supporting other constructions and of being practiced or of being carried out in various ways.

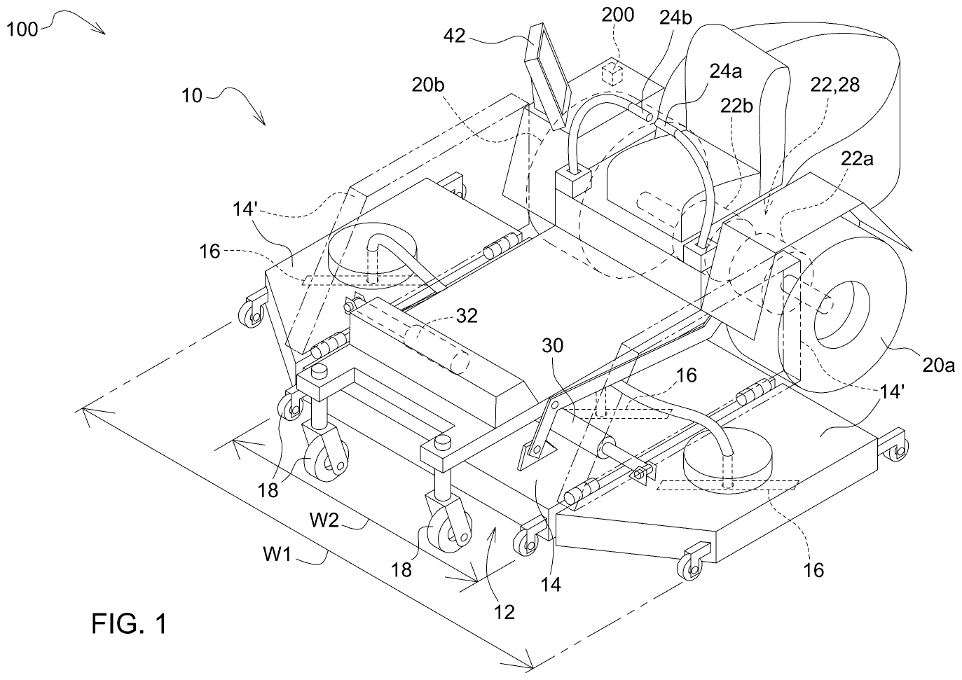

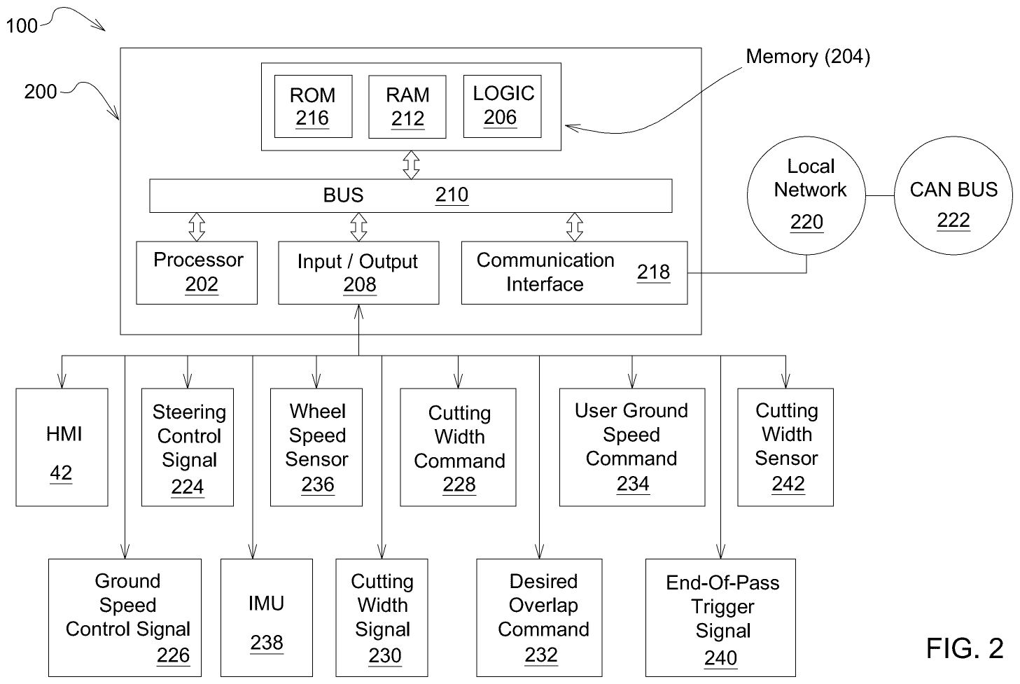

FIG. 1 illustrates a mower 10 with an adjustable cutting width. For example, the cutting width can be changed between a first cutting width W1 and a second cutting width W2. Any suitable means for adjusting the cutting width may be employed. FIG. 1 illustrates the mower 10 having a mower blade arrangement 12. The mower blade arrangement 12 may include a blade deck(s) 14 and at least one movable blade deck 14′ being movable relative to the blade deck(s) 14 out of cutting engagement with the grass to adjust the cutting width of the mower 10. The dash-dot-dot lines in FIG. 1 illustrate the at least one movable deck 14′ (two in the illustrated implementation) raised out of cutting engagement. Thus, the first cutting width W1 corresponds to a raised deck wing state of the mower 10 in which the at least one movable blade deck 14′ is/are raised. The second cutting width W2 corresponds to a lowered deck wing state of the mower 10 in which the at least one movable blade deck 14′ is/are down. Other cutting widths are possible, in any quantity and/or magnitude. For example, the illustrated implementation includes two movable blade decks 14′. An intermediate wing deck state in which one of the movable blade decks 14′ is raised and another of the movable blade decks 14′ is lowered may result in a third cutting width W3 (not shown but readily understood from FIG. 1 by those having ordinary skill in the art), which may have a width magnitude that is between that of W1 and W2.

The blade decks 14, 14′ may each include at least one cutting mechanism 16 such as a rotary blade(s) for cutting grass. In other implementations, the at least one cutting mechanism 16 may include a cutting reel(s), or any other suitable type of cutting mechanism for cutting the grass. The mower blade arrangement 12 may include a lift actuator(s) 30, 32 for moving each of the at least one movable blade deck(s) 14′ relative to the blade deck(s) 14. In other implementations, the mower blade arrangement 12 may include other types of lift actuator(s). The mower blade arrangement 12 may move in any suitable way to adjust the cutting width of the mower 10. FIG. 1 illustrates the mower 10 embodied as a zero-turn radius (ZTR) mower. However, in other implementations, the mower 10 may be embodied as a lawn tractor mower, a standing mower, a walk-behind mower, a push mower, an autonomous mower, etc., or any other suitable type of mower. The adjustable mower blade arrangement 12 may be configured to be controllable via electronic control signals to move the cutting mechanism(s) 16 to change the cutting width.

The mower 10 may include a plurality of wheels 18 including at least one drive wheel 20a, 20b configured to provide traction for moving the mower 10 across the ground G. In the illustrated implementation, a left drive wheel 20a and a right drive wheel 20b are employed; however, it should be understood that any number of drive wheels, such as one, two, three, four, or more may be employed.

The mower 10 may include a steering mechanism 28 configured turn the mower 10. Turning or steering the mower, as used herein, refers to changing the heading of the mower 10 as the mower 10 moves across the ground G. In other words, changing the direction of travel of the mower 10 by directing movement of the mower 10 towards the left or the right as the mower 10 moves across the ground G. In the example of FIG. 1, the steering mechanism 28 may include a wheel drive mechanism 22 in accordance with a ZTR mower configuration. In other examples, the steering mechanism 28 may be separate from the drive mechanism 22 (e.g., in a lawn tractor in which the steering mechanism 28 steers the heading of at least one wheel and a separate drive mechanism 22 independently controls the ground speed). The example ZTR mower 10 employs at least two different wheel drives (e.g., a first wheel drive mechanism 22a and a second wheel drive mechanism 22b) individually controllable to control a ground speed of the mower 10 and to steer. For example, the steering mechanism 28 of the ZTR mower 10 may include the first and second wheel drive mechanisms 22a, 22b (left and right, respectively) operable independently of each other. As one example, the first and second wheel drive mechanisms 22a, 22b may be hydrostatic transmissions or transmissions of any other suitable type, in any combination. The first wheel drive mechanism 22a may control rotation of the left drive wheel 20a. The second drive mechanism 22b may control rotation of the right drive wheel 20b. Thus, the left and right drive wheels 20a, 20b are driven and controlled independently. Each drive mechanism 22a, 22b may include a hydrostatic valve (only illustrated schematically as the part of the drive mechanisms 22a, 22b) controllable by electronic control signals to adjust rotation of the respective wheel 20a, 20b. In other implementations, the first and second drive mechanisms 22a, 22b may include left and right electric drive motors. The left and right electric drive motors may be controllable by way of left and right inverters (only illustrated schematically as part of the drive mechanisms 22a, 22b), for example. Thus, the steering mechanism 28 may include at least one of: an electric motor, a hydrostatic transmission, a steering actuator for turning the heading of one or more wheels (e.g., a mechanical arrangement such as a rack and pinion or other linkage system, an electronically controllable actuator, etc.), etc. Any other suitable type of steering mechanism may be employed.

The example ZTR mower 10 of FIG. 1 may include any suitable type of control member(s) 24a, 24b. As one example, the control member(s) 24a, 24b includes left and right control members, respectively. The left control member 24a may control the left drive wheel 20a and the right control member 24a may control the right drive wheel 20b. The left and right control members 24a, 24b may each have any suitable structure for being controlled by an operator to command desired ground speed and direction. For example, the operator may move both control members 24a, 24b, which may be configured as levers, to command the mower 10 to move at a selected ground speed and to steer. The control members 24a, 24b may commonly be referred to as sticks in some examples. The amount of displacement of the control member(s) 24a, 24b from a neutral position may control the magnitude of the commanded ground speed. The left and right control members 24a, 24b may be displaced the same amount in the same direction to drive the mower 10 straight and may be displaced differently from each other to steer through turns. Steering may be achieved by having different left and right drive wheel speeds and/or directions. Any suitable type of control member(s) may be employed. In other examples, there may be separate control members for steering and speed, such as a steering wheel and an accelerator, respectively.

The mower 10 also includes a human-machine interface (HMI) 42 (e.g., including a display and input members, such as any combination of one or more of a touch screen, button, dial, joystick, mouse pad, graphical user interface, microphone, or the like) with which the operator can input settings, preferences, commands, etc. to control various aspects of the mower 10. The operator inputs are communicated to a controller 200 by wired or wireless signals. Information may also be communicated to the operator via the HMI 42, e.g., from the controller 200.

A mowing pass alignment system 100 for turning a mower 10 with an adjustable cutting width is disclosed herein. The mowing pass alignment system 100 may be employed with the mower 10 illustrated in FIG. 1 or with any other type of mower.

The mowing pass alignment system 100 includes a controller 200, such as an electronic controller. The controller 200 may be operatively coupled with the steering mechanism 28. For example, the controller 200 may be operable to send a steering control signal 224, e.g., in the form of an electronic control signal, to the steering mechanism 28 to change the direction of travel of the mower 10. In implementations where the steering mechanism 28 includes the first and second wheel drive mechanisms 22a, 22b (such as may be the case with a ZTR mower), the controller 200 may be operable to send the steering control signal 224 to the steering mechanism 28 that both controls the direction of travel and controls the ground speed of the mower 10. In implementations where the steering mechanism 28 is separate from the wheel drive mechanism 22, the controller 200 may also be operable to send a ground speed command 226, e.g., in the form of a second electronic control signal, to the wheel drive mechanism 22 (e.g., embodied as a prime mover) to change the ground speed of the mower 10 independently of the steering control signal 224.

The controller 200 may receive a cutting width command 228. The cutting width command 228 may be an electronic signal inputted by the operator (e.g., via the HMI 42 or other suitable input mechanism) indicative of a desired cutting width W1, W2. The cutting width command 228 may, for example, control the first and second lift actuators 30, 32, or other width-adjusting mechanism.

The controller 200 may include a bus 210 or other communication mechanism for communicating information and a processor 202 coupled with the bus 210 for processing information. The controller 200 includes a memory 204 (which may also be referred to herein as a main memory 204), which may comprise random access memory (RAM) 212 or other dynamic storage devices for storing information and instructions such as mowing pass alignment logic 206 to be executed by the processor 202, and/or read only memory (ROM) 216 or other static storage device for storing static information and instructions for the processor 202. In other implementations, it may be possible to place the mowing pass alignment logic 206 on a static storage device such as the ROM 216. The memory 204 may be a non-transitory, non-volatile memory device and operable to store information and instructions executable by the processor 202. The controller 200 may also include an input/output 208 for receiving input signals and providing output signals. Additionally, the controller 200 and, in particular a communication interface 218 of the controller 200, may be operatively coupled to a local network 220 and/or a CAN bus 222. The term “controller” as used herein may encompass a single controller or a group of controllers in communication with each other.

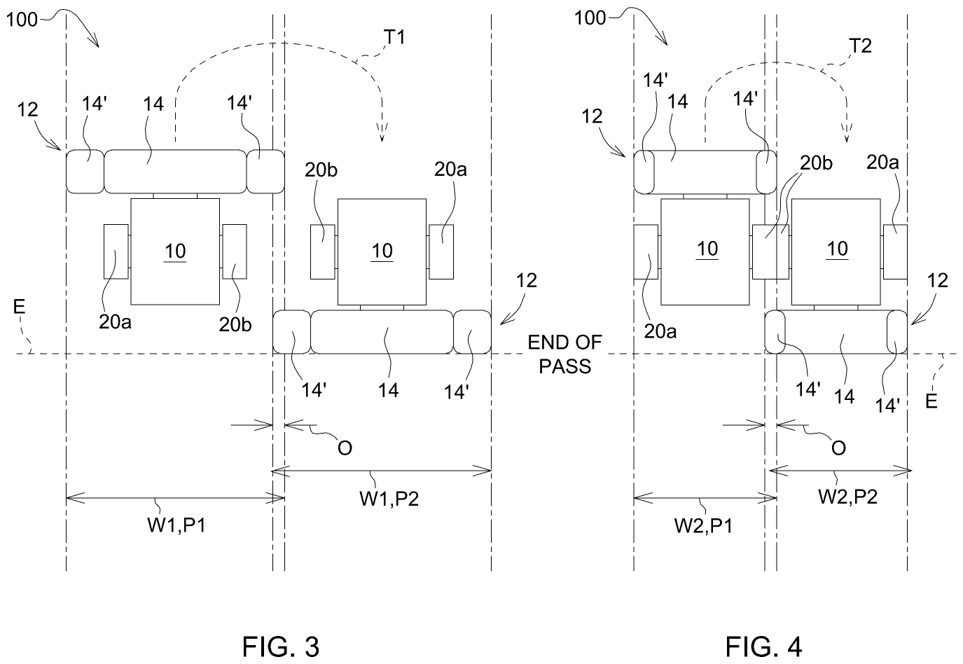

The mowing pass alignment logic 206 provides adaptive turning of the mower 10 at the end E of a pass. Adaptive turning automatically or semi-automatically turns the mower 10 around, generally 180 degrees, to align a next pass P2 directly adjacent the previous pass P1 (see FIGS. 3 and 4). It may be desirable for the next pass P2 to be generally parallel to the previous pass P1. The mowing pass alignment logic 206 may be configured to receive an electronic signal corresponding to the cutting width (e.g., a cutting width signal 230). The cutting width signal 230 may come from any suitable source. As one example, the cutting width signal 230 may be communicated by the lift actuator(s) 30, 32. The lift actuator(s) 30, 32 may communicate with the controller 200, either directly or via another controller of the mower 10 such as a vehicle control unit (VCU). The communication may be by way of the CAN bus 222 and/or the input/output 208 or by any other suitable communication means. The lift actuator(s) 30, 32 may communicate its position such that the mowing pass alignment logic 206 can determine the cutting width based on the lift actuator(s)'s position. The lift actuator(s) 30, 32 may communicate position through the entire length of the actuator stroke. In another example, the cutting width signal 230 may be derived from the most recent cutting width command 228. In another example, the cutting width signal 230 may be derived from a cutting width sensor(s) 242 configured to sense the current cutting width. For example, the cutting width sensor(s) 242 may include a proximity sensor (e.g., a Hall effect sensor or other suitable proximity sensor), an optical sensor, etc., or any other type of suitable sensor.

The mowing pass alignment logic 206 may be configured to control the steering mechanism 28 based at least in part on the cutting width signal 230 in order to turn the mower 10 at the end E of a pass. As is apparent from the description herein of the possible mower implementations, the first and second wheel drive mechanisms 22a, 22b may be part of the steering mechanism 28 and therefore may be controlled by the mowing pass alignment logic 206 based at least in part on the cutting width signal 230. Wheel drive (e.g., ground speed control) through the turn may be provided for automatically by the mowing pass alignment logic 206, manually by the operator, or a combination of both, in any suitable manner.

The steering mechanism 28 may be controlled by the mowing pass alignment logic 206 to execute a desired turn path (e.g., T1, T2, etc.), as illustrated in FIGS. 3 and 4. Controlling the steering mechanism 28 may align the next pass P2, as illustrated in FIGS. 3-4. The mowing pass alignment logic 206 takes into account the current cutting width (e.g., W1 or W2) of the mower 10 at the end E of a pass P1 and automatically steers the mower 10 to align the next pass P2.

The next pass P2 may have a desired overlap O with the previous pass P1. In some implementations, the desired overlap O may be set by operator input of a desired overlap command 232, e.g., via the HMI 42 or any other suitable input mechanism. In some implementations, the desired overlap O may be automatically selected or predetermined by the mowing pass alignment logic 206. The desired overlap O may be zero or greater than zero. The mowing pass alignment logic 206 may determine the desired turn path based, at least in part, on the desired overlap O. FIG. 3 illustrates an example of a desired turn path T1 when the mower 10 has the cutting width W1 (e.g., a larger cutting width configuration), and FIG. 4 illustrates an example of a desired turn path T2 when the mower 10 has the cutting width W2 (e.g., a relatively smaller cutting width configuration). The illustrated turn paths T1, T2 are highly schematic, and implementations of the turn path may take on any desired shape, curvature, turning radius, number of direction changes (e.g., a U-turn, a 2-point turn, a 3-point turn, etc.), etc.

The mowing pass alignment logic 206 may also control the steering mechanism 28 based in part on a user-inputted ground speed command 234. The user-inputted ground speed command 234 may be inputted by the operator via any suitable mechanism, such as the control member(s) 24a, 24b, or an accelerator, a throttle, another speed-commanding mechanism, etc. In one example, the mowing pass alignment logic 206 may select a turn path that can be achieved at or near the user-inputted ground speed. The mowing pass alignment logic 206 may control the actual ground speed to approach the user-inputted ground speed during the turn. In other implementations, the mowing pass alignment logic 206 may select a ground speed during the turn.

Adaptive turning may be triggered, at least in part, when the end E of a pass is reached. The controller 200 may be configured to receive an end-of-pass trigger signal 240 corresponding to the end E of a pass being reached. The end-of-pass trigger signal 240 may tell the mowing pass alignment logic 206, at least in part, to initiate adaptive turning. The end-of-pass trigger signal 240 may come from any suitable source, or combination of sources, either manual or automatic. For example, the end-of-pass trigger signal 240 may be inputted manually by the operator at the end E of a pass. The user input may be made via any suitable mechanism, such as the HMI 42 or any suitable button or buttons. As one example, the display of the HMI 42 may be used as an input. As another example, an input mechanism may be located on one or both of the control members 24a, 24b. The input mechanism may be dedicated to receiving end-of-pass input or may have some other shared functionality. There may be separate end-of-pass inputs for left and right, which may tell the mowing pass alignment logic 206 which direction to turn the mower 10. In other examples, the end-of-pass trigger signal 240 may be derived from a sensor, from machine learning, or any other suitable way of identifying the end-of-pass.

In some implementations, the mowing pass alignment logic 206 may initiate adaptive turning when: 1) the end-of-pass trigger signal 240 is received and 2) the user ground speed command 234 is moved out of neutral (e.g., is greater than zero). As one example, the user ground speed command 234 is moved out of neutral when at least one of the left or right control members 24a, 24b is moved out of neutral to command a ground speed greater than zero. The magnitude of ground speed during the adaptive turning may be controlled by the user ground speed command 234 in such implementations, though other implementations in which the mowing pass alignment logic 206 may automatically control the ground speed are possible. Thus, adaptive turning may be executed at a predefined speed or at a speed dependent on the user ground speed command 234. Direction of the adaptive turning (e.g., left or right) may be controlled by how the operator has issued the ground speed command 234. For example, if the operator issues the ground speed command 234 using the left control member 24a then a first direction is commanded (e.g., a right turn) and if the operator issues the ground speed command 234 using the right control member 24b then a second direction is commanded (e.g., a left turn). In other examples, the direction of the adaptive turning may be controlled by an optical sensor input. The mowing pass alignment logic 206 may determine the direction based on the optical sensor input (e.g., a camera or a neural network that processes a camera's image(s) and outputs a determination of which side has/has not yet been mowed).

The mowing pass alignment logic 206 may also control the steering mechanism 28 (and optionally also the ground speed) based in part on wheel speed feedback from a wheel speed sensor 236. Wheel speed feedback may include a signal that corresponds to a measured rotational wheel speed of any one or more of the plurality of wheels 18, including the drive wheels 20a, 20b. Wheel speed feedback may be measured by any suitable type of sensor. Wheel speed feedback allows the mowing pass alignment logic 206 to take into account differences between expected and actual wheel behavior, such as from wheel slip, to achieve the desired turn path and, ultimately, the desired alignment. Wheel speed feedback may reduce error in some implementations but is optional in other implementations.

The mowing pass alignment system 100 may also include an inertial measurement unit (IMU) 238. The IMU 238 may measure the mower's acceleration, position (e.g., in three or fewer orthogonal directions), orientation, inclination, force, and/or angular rate. The IMU 238 may include an accelerometer(s), a gyroscope(s), and/or a magnetometer(s), a global positioning system, and/or any other suitable instrument or combination of instruments. The mowing pass alignment logic 206 may also control the steering mechanism 28 (and optionally also the ground speed) based in part on feedback from the IMU 238. IMU feedback may include a signal or signals that correspond(s) to any combination of a measured position, orientation, inclination, force, angular rate, and/or acceleration of the mower 10. IMU feedback allows the mowing pass alignment logic 206 to take into account differences between expected and actual mower position to achieve the desired turn path and, ultimately, the desired alignment. IMU feedback may reduce error in some implementations but is optional in other implementations.

Controlling the steering mechanism 28 (and optionally also the ground speed) may include selecting a predetermined turn path from a plurality of turn paths (e.g., T1, T2, etc.) saved in the memory 204. The predetermined turn path provides alignment of the next pass for the signaled cutting deck width. In other implementations, the predetermined turn path (e.g., T1, T2, etc.) may be calculated by the mowing pass alignment logic 206. Determination of the predetermined turn path may be based on any combination of one or more of: cutting width, desired overlap, commanded ground speed, or other factors described herein.

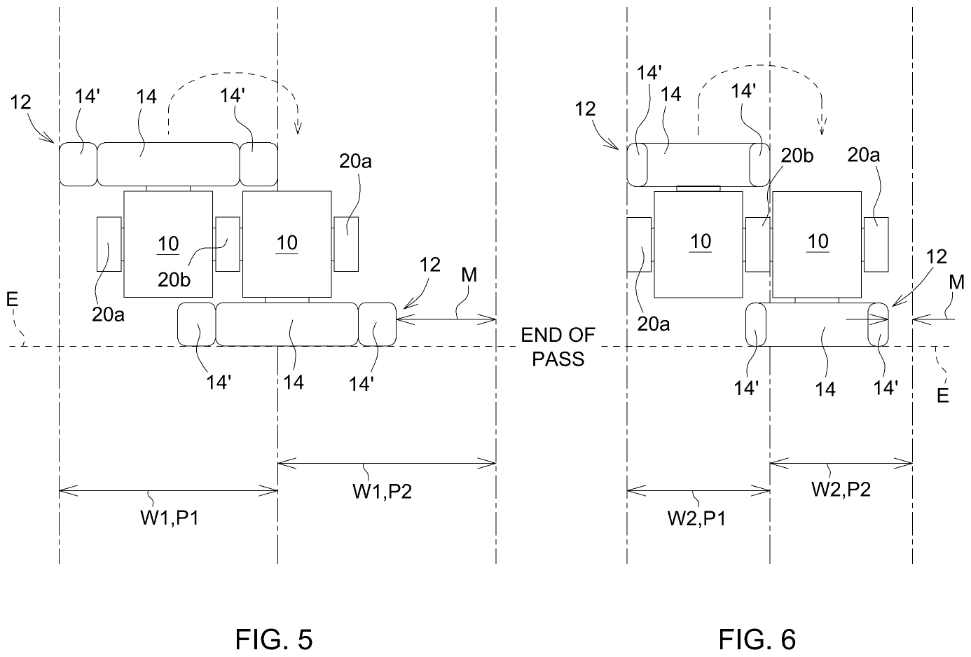

Without the mowing pass alignment logic 206, steering at the end E of a pass may result in misalignment for many reasons. For example, the operator may not take into account the current cutting width configuration of the mower. Misalignment M of the next pass is illustrated in FIGS. 5-6 and may occur as a result of the operator steering the mower 10 without making good utilization of the available cutting width W1, W2. Misalignment M may result in too much overlap in adjacent passes P1, P2, meaning the available cutting width is not being utilized to a desirable level. Misalignment M may also result in non-parallel passes with uneven or inconsistent overlap between adjacent passes P1, P2 as the operator attempts to correct the misalignment. The mowing pass alignment logic 206 may reduce error, provide consistent straightness from pass to pass, provide consistent overlap from pass to pass, and/or may reduce turf damage compared to operator-controlled turns, thus improving alignment.

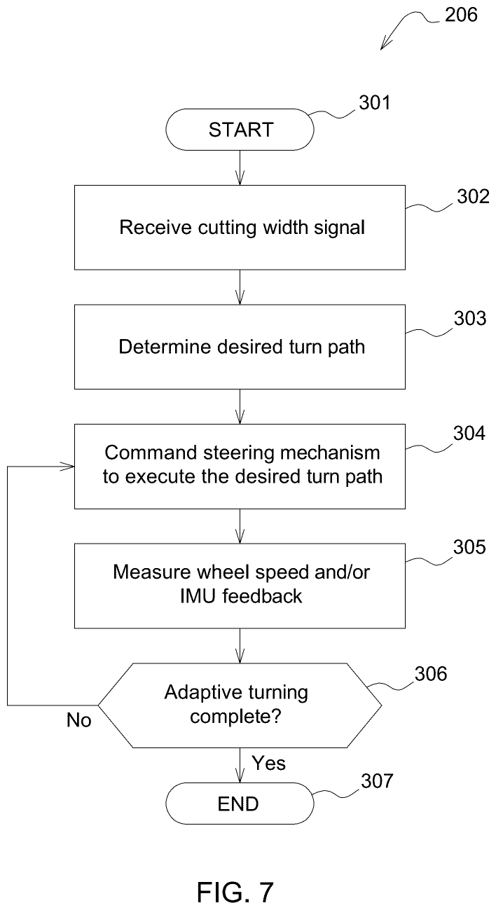

FIG. 7 illustrates at least a portion of the mowing pass alignment logic 206 in flow chart form. Though steps 301-307 are described and illustrated in sequential order herein, one of ordinary skill will recognize that the steps 301-307 may be performed in other suitable orders, some steps 301-307 may be performed at the same time, and some steps 301-307 may be omitted. It should be understood that any numbering or lettering used herein to list steps, methods, or processes is used for purposes of separating items in a list and does not imply any particular order to the listed steps, methods, or processes. Additional steps and/or details are apparent from the disclosure of the mowing pass alignment logic 206 herein (e.g., above).

At step 301, adaptive turning is enabled. Adaptive turning may be enabled when the end-of-pass trigger signal 240 is received. At step 302, the cutting width signal 230 is received. At step 303, the mowing pass alignment logic 206 determines (e.g., selects or computes) a desired turn path. The determination may be based, at least in part, on the cutting width signal 230. The determination may be based, at least in part, on the desired overlap command 232. The determination may be based, at least in part, on the user ground speed command 234. At step 304, the mowing pass alignment logic 206 commands the steering mechanism 28 to execute the desired turn path. At step 304, the ground speed may be commanded by the mowing pass alignment logic 206 (e.g., to a predetermined ground speed) and/or by user input (e.g., the user ground speed command 234). At step 305, wheel speed measurements and/or IMU measurements may be fed back to the controller 200. The feedback may be continuous or in any other suitable form. Thus, the adaptive turning may occur as a closed loop system, which helps reduce error between the desired turn path and the actual turn path of the mower 10 in some implementations but is optional in other implementations. At step 306, if the adaptive turning is not complete, then the mowing pass alignment logic 206 continues to execute the desired turn path. If the adaptive turning is complete, then the mowing pass alignment logic 206 ends adaptive turning at step 307. Completion of the adaptive turn may be determined based on the IMU measurements, for example. In other examples, completion of the adaptive turn may be determined by an optical sensor, a user input, etc. At step 307, adaptive turning ends and steering and ground speed control returns to normal.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “left” and “right” are used as relative terms and do not represent limitations on the scope of the present disclosure, as defined by the appended claims. Accordingly, the terms “left” and “right” may be replaced with the terms “first” and “second.” Furthermore, the teachings may be described herein in terms of functional and/or logical block components or various processing steps, which may be comprised of any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” or the like indicate configurations or arrangements that potentially include individual elements of the list, or any combination thereof. For example, “at least one of A, B, and C” or “one or more of A, B, and C” indicates the possibilities of only A(s), only B(s), only C(s), or any combination of two or more of A(s), B(s), and C(s) (e.g., A(s) and B(s); B(s) and C(s); A(s) and C(s); or A(s), B(s), and C(s)).

Thus, the disclosure provides, among other things, a mower having a mowing pass alignment system for turning the mower into alignment with a next pass. Various features and advantages of the disclosure are set forth in the following claims.

What is claimed is:

1. A mowing pass alignment system for turning a mower with adjustable cutting width, the mowing pass alignment system comprising:
a mower blade arrangement having an adjustable cutting width;
a plurality of wheels including at least one drive wheel configured to provide traction for moving the mower across the ground;
a steering mechanism configured to turn the mower; and
a controller operatively coupled with the steering mechanism, the controller including a processor, a memory operatively coupled with the processor, and mowing pass alignment logic stored in the memory and being executable by way of the processor such that the controller is configured to:
receive an electronic signal corresponding to the cutting width; and
control the steering mechanism to turn the mower into alignment with a next pass based at least in part on the cutting width.

2. The mowing pass alignment system of claim 1, further comprising a lift actuator actuatable to change the cutting width of the mower blade arrangement, wherein the lift actuator generates the electronic signal corresponding to the cutting width.

3. The mowing pass alignment system of claim 2, wherein the lift actuator uses CAN to communicate the electronic signal to the controller.

4. The mowing pass alignment system of claim 1, further comprising a cutting width sensor configured to generate the electronic signal corresponding to the cutting width.

5. The mowing pass alignment system of claim 1, wherein the electronic signal corresponding to the cutting width is derived from a most recent cutting width command inputted by a user.

6. The mowing pass alignment system of claim 1, wherein the controller is further configured to:
receive a desired overlap command corresponding to a desired overlap between directly adjacent mowing passes; and
further control the steering mechanism based on the desired overlap command.

7. The mowing pass alignment system of claim 1, wherein the controller is further configured to receive an end-of-pass trigger signal at the end of a pass for enabling the turn.

8. The mowing pass alignment system of claim 7, wherein the end-of-pass trigger signal is derived from one or both of: a user input or a sensor.

9. The mowing pass alignment system of claim 1, wherein the steering mechanism includes at least one of: an electric motor, a hydrostatic transmission, and a steering actuator.

10. The mowing pass alignment system of claim 1, wherein the steering mechanism includes a wheel drive mechanism configured to steer and drive the at least one drive wheel, or wherein the steering mechanism is configured to steer the heading of at least one of the plurality of wheels and a separate wheel drive mechanism is configured to control a mower ground speed.

11. The mowing pass alignment system of claim 1, wherein the controller is further configured to control a ground speed of the mower during the turn based on a user-inputted ground speed command.

12. The mowing pass alignment system of claim 1, wherein the control of the steering mechanism is further based on one or both of wheel speed feedback or IMU feedback.

13. The mowing pass alignment system of claim 1, wherein the at least one drive wheel includes a first drive wheel and a second drive wheel, wherein the steering mechanism includes a first drive mechanism configured to drive the first drive wheel and a second drive mechanism configured to drive the second drive wheel, wherein the control of the steering mechanism includes controlling the first drive mechanism and the second drive mechanism independently of each other to steer the mower from an end of pass into the next pass.

14. The mowing pass alignment system of claim 13, further comprising a first control member configured to receive user input for controlling the first drive mechanism and a second control member configured to receive user input for controlling the second drive mechanism, wherein the turning is executed at a ground speed dependent on a position of one or both of the first control member or the second control member.

15. The mowing pass alignment system of claim 1, wherein the controller is further configured to:
determine a desired turn path based at least in part on the electronic signal corresponding to the cutting width; and
execute the desired turn path using the control of the steering mechanism.

16. A mower comprising:
a mower blade arrangement having an adjustable cutting width;
a plurality of wheels including at least one drive wheel configured to provide traction for moving the mower across the ground;
a steering mechanism configured to turn the mower; and
a controller operatively coupled with the steering mechanism, the controller including a processor, a memory operatively coupled with the processor, and mowing pass alignment logic stored in the memory and being executable by way of the processor such that the controller is configured to:
receive an electronic signal corresponding to the cutting width; and
control the steering mechanism to turn the mower into alignment with a next pass based at least in part on the cutting width.

17. A mowing pass alignment system for turning a mower with adjustable cutting width, the mowing pass alignment system comprising:
a mower blade arrangement having an adjustable cutting width;
a plurality of wheels including at least one drive wheel configured to provide traction for moving the mower across the ground;
a steering mechanism configured to turn the mower; and
a controller operatively coupled with the steering mechanism, the controller including a processor, a memory operatively coupled with the processor, and mowing pass alignment logic stored in the memory and being executable by way of the processor such that the controller is configured to:
receive an electronic signal corresponding to the cutting width;
determine a desired turn path based at least in part on the electronic signal; and
execute the desired turn path to align the mower to a next pass.

18. The mowing pass alignment system of claim 17, wherein the controller is further configured to:
receive a desired overlap command corresponding to a desired overlap between directly adjacent mowing passes; and
determine the desired turn path based on the desired overlap command.

19. The mowing pass alignment system of claim 17, wherein the controller is further configured to receive an end-of-pass trigger signal at the end of a pass for enabling execution of the desired turn path, and wherein the end-of-pass trigger signal is derived from one or both of: a user input or a sensor.

20. The mowing pass alignment system of claim 17, wherein determining the desired turn path includes selecting the desired turn path from a plurality of predetermined turn paths saved in the memory or calculating the desired turn path.
